(19) United States
(12) Patent Application Publication
(10) Pub. No.: US 2022/0292501 A1
(43) Pub. Date: Sep. 15, 2022

(54) NESTED FUNDS VERIFICATION SYSTEM

(71) Applicant: Bank of America Corporation, Charlotte, NC (US)

(72) Inventors: Michael G. Horstman, West Orange, NJ (US); Linda Haddad, Concord, CA (US)

(21) Appl. No.: 17/543,821

(22) Filed: Dec. 7, 2021

Related U.S. Application Data
(60) Provisional application No. 63/161,052, filed on Mar. 15, 2021.

(51) Int. Cl. G06Q 20/40; G06F 21/62

(52) U.S. Cl. CPC G06Q 20/401; G06F 21/6245

(57) ABSTRACT

A system for protecting the privacy of consumer assets. The system may include a web-based interface. The web-based interface may include an entity-facing side and a consumer-facing side. The system may include an internal processing executable executing on a processor. The internal processing executable may be obscured from and inaccessible to, both the entity-facing side and the consumer-facing side. The entity-facing side of the web-based interface may prompt the user to provide opt-in permission, receive profile data from the consumer, generate a record for the consumer, enter a minimum asset amount and initiate a funds verification process for the consumer. The consumer-facing side of the web-based interface may receive opt-in permission and receive asset data. The executable may execute a query using on the one or more assets using existing financial rails and/or new financial rails.

### CROSS-REFERENCE TO RELATED APPLICATION

This application is a non-provisional of U.S. Provisional Patent Application No. 63/161,052 filed Mar. 15, 2021 entitled “NESTED FUNDS VERIFICATION SYSTEM” which is hereby incorporated by reference herein in its entirety.

### FIELD OF TECHNOLOGY

This disclosure relates to systems for protecting the privacy of consumer assets.

### BACKGROUND OF THE DISCLOSURE

Entities and individuals may wish to engage in various relationships with counterpart entities. Such relationships may be financial relationships. Such relationships may involve lines of credit. Such relationships may be dependent on the financial standing of the entity or individual. Such relationships may involve services that require the counterpart entity's trust of the entity or individual. Such trust may extend to the level of confidence in the entity's statements regarding the condition of the entity's assets.

Conventionally, an entity or individual, attempting to qualify for a specific relationship with a counterpart entity may present paper-based financial statements to the counterpart entity in order for the counterpart entity to trust in the entity or individual. However, paper-based financial statements have various weaknesses.

Firstly, paper-based financial statements only show a point in time. As such, an amount of money can be moved into the account just prior to the issuance of a paper statement and can be moved out of the account immediately after the statement. Secondly, paper-based financial statements may have questionable authenticity. Finally, paper-based financial statements show more information than required to qualify for the relationship. Therefore, paper-based financial statements are both prone to questionable authenticity and share more information than may be required.

As such, an autonomous nested funds verification system may be desirable. Such a system may determine whether an entity or individual qualifies for a specific relationship absent providing necessary details to the counterpart entity with which the relationship is being requested.

### SUMMARY OF THE DISCLOSURE

A system for protecting the privacy of a consumer during the execution of a nested funds verification of the consumer is provided. The system may include a web-based interface and an internal processing executable.

The web-based interface may include an entity-facing side and a consumer-facing side.

The internal processing executable may be obscured from, and inaccessible to, both the entity-facing side and the consumer-facing side of the web-based interface.

The entity-facing side of the web-based interface may prompt the user to provide opt-in permission. The entity-facing side of the web-based interface may receive profile data from the consumer. The entity-facing side of the web-based interface may generate a record for the consumer. The entity-facing side of the web-based interface may receive user input of a minimum asset amount. The entity-facing side of the web-based interface may initiate a funds verification process for the consumer.

The consumer-facing side of the web-based interface may provide the opt-in permission for the web-based interface to access data associated with the consumer. The consumer-facing side of the web-based interface may receive user input relating to assets data associated with one or more assets.

It should be appreciated that the consumer may define the accounts that add up to the dollar amount and the entity may not know how many accounts there are and the locations of the accounts. The entity may set the minimum asset amount and a time frame for which the minimum asset amount was available within each of the accounts.

Upon receipt of the opt-in permission from the consumer-facing side of the web-based interface, the internal processing executable may query the one or more assets to determine whether the one or more assets, alone or in combination include the minimum assets amount. The query may be executed multiple instances according to a predetermine schedule. A notification may be presented to the consumer-facing side prior to execution of each query instance included in the plurality of instances.

The query may include determining whether the one or more assets in the minimum assets amount has been maintained for a predetermined time period. The predetermined time period may be a historical predetermined time period. The historical predetermined time period may begin a predetermined amount of time prior to a current date.

The executing the query may include identification of a first plurality of assets, a secondary plurality of assets and/or a tertiary plurality of assets. The secondary plurality of assets may communicate with the first plurality of assets for the historical period of time. The secondary plurality of assets may communicate with the first plurality of assets for a period of time other than the historical period of time. The tertiary plurality of assets may communicate with the secondary plurality of assets for the historical period of time. The tertiary plurality of assets may communicate with the secondary plurality of assets for a period of time other than the historical period of time.

The executing the query may include identification of a total amount of combined assets for the first plurality of assets, secondary plurality of assets and the tertiary plurality of assets. The executing the query may include executing the query on the total amount of combined assets.

In some embodiments, the first plurality of assets may correspond to liquid assets, such as bank account. The secondary plurality of assets may correspond to equity associated with a parcel of real estate. The tertiary plurality of assets may correspond to values of valuables, such as precious gems, precious metals, valuable antiques and any other suitable valuables.

The internal processing executable may determine, based on a comparison of the one or more assets to the minimum assets amount, an approval or a denial of the query.

The internal processing executable may present the approval or the denial to the entity-facing side and the consumer-facing side of the web-based interface.

The internal processing executable may shield the entity-facing side and the consumer-facing side from details included in the one or more assets. Examples of such details may include specific transaction details.

The internal processing executable may utilize existing financial rails to execute the query on the one or more assets or the total amount of combined assets.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative diagram in accordance with principles of the invention;

FIG. 2 shows another illustrative diagram in accordance with principles of the invention;

FIG. 3 shows yet another illustrative diagram in accordance with principles of the invention;

FIG. 4 shows still another illustrative diagram in accordance with principles of the invention;

FIG. 5 shows yet another illustrative diagram in accordance with principles of the invention;

FIG. 6 shows still another illustrative diagram in accordance with principles of the invention; and

FIG. 7 shows still yet another illustrative diagram in accordance with principles of the invention.

### DETAILED DESCRIPTION OF THE DISCLOSURE

Systems and methods for protecting the privacy of a consumer during the execution of a nested funds verification of the consumer is provided.

The method may receive a request for initiation of predetermined relationship. The request may be received from a consumer. The request may be received at an entity.

The method may include receiving a personal identifier. The personal identifier may be received from the consumer. The personal identifier may be received at the entity.

The method may include initiating a request for permission to query a plurality of confidential files associated with the consumer. The initiation may be executed at an entity-side user interface. The confidential files may be associated with the consumer's assets.

The method may include receiving user input at the entity-side user interface. The user input may include the personal identifier associated with the consumer.

The method may include delivering a request to approve opt-in permission to query the consumer. The request may be delivered to the consumer. The request may be delivered via a consumer-side user interface.

The method may include receiving approval of the request to query the consumer. The approval may be received from the consumer.

The method may include executing the query on the plurality of confidential files identified by the personal identifier. The executing may be transparent to the consumer as to which files are queried. The executing may be obscured from view and inaccessible by the entity. The executing the query may utilize existing financial rails to execute the query on the plurality of confidential files.

The executing the query may include identifying a bank account. The bank account may be identified by one or more confidential files included in the plurality of confidential files. The executing the query may include determining the current value for the bank account in a predetermined currency.

In some embodiments, the executing the query may include identifying a plurality of bank accounts identified by one or more confidential files included in the plurality of confidential files. The executing may include determining the lowest value, for the past predetermined time period, for each bank account included in the plurality of bank accounts. The lowest value may be presented in a uniform predetermined currency. As such, a foreign exchange (“FX”) conversion component may be used to convert the bank account balances to a uniform currency. The FX conversion component may be important for aggregating the account balances into an aggregated amount.

The executing may include aggregating, into an aggregated amount, all of the values of each bank account included in the plurality of bank accounts. The executing may include comparing a minimum amount, inputted by the entity to the total amount of combined assets. The executing may include approving the query when the minimum amount is less than or equal to the total amount of combined assets. The executing may include denying the query when the minimum amount is greater than the total amount of combined assets.

In certain embodiments, the executing may include identifying a first plurality of bank accounts, secondary plurality of bank accounts and tertiary plurality of bank accounts. The first plurality of bank accounts, secondary plurality of bank accounts and tertiary plurality of bank accounts may be identified by one or more confidential files included in the plurality of confidential files. The secondary plurality of bank accounts may have been identified because each of the secondary plurality of bank accounts may communicate with the first plurality of bank accounts for the past predetermined time period. The tertiary plurality of bank accounts may have been identified because each of the tertiary plurality of bank accounts may have communicated with the secondary plurality of bank accounts for the past predetermined time period. The executing may include identifying a total amount of combined assets for the first plurality of bank accounts, secondary plurality of bank accounts and tertiary plurality of bank accounts.

The query may include identifying whether the confidential files fulfill one or more criteria. Such criteria may include a predetermined amount of funds. Such criteria may include transactions under a predetermined amount. Such criteria may include a required asset class. Asset classes may include liquid funds, real estate, valuables and any other suitable assets. For example, a certain percentage of the required funds may be included in liquid funds as opposed to value included in real estate. In such an example, 60% of the funds may be required to be in liquid funds, while 40% of the funds may be accessible from other assets. In other examples, 100% of the funds may be required to be in liquid funds. In other examples, other suitable percentages may be utilized. Such criteria may include any suitable criteria.

In some embodiments, the method may include also include receiving user input at the entity-side user interface. The user input may include a predetermined asset threshold.

In such embodiments, the method may include approving the query when the query identifies that the consumer has access to greater than the predetermined asset threshold. The method may include denying the query when the query identifies that the consumer has access to less than the predetermined asset threshold.

In certain embodiments, the method may include determining when the query identifies that the consumer has access to more than a predetermined asset threshold. The method may also determine a total amount above the predetermined asset threshold. The method may also determine whether the total amount above the predetermined asset threshold exceeds a second predetermined asset threshold. The second predetermined asset threshold may be used to determine the consumer's eligibility for financial aid.

In certain embodiments, the consumer may receive a notification each time the plurality of confidential files is queried.

The method may include presenting an approval or a denial of the query. The approval or denial may be presented to the entity at the entity-side user interface. The approval or denial may be presented to the consumer at the consumer-side user interface.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

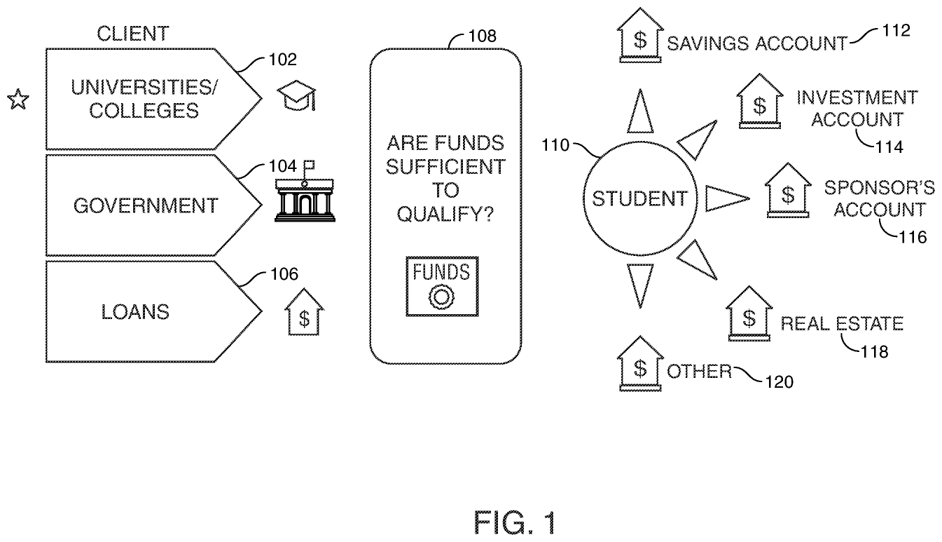

FIG. 1 shows an exemplary flow diagram. The flow diagram involves a nested funds verification system. The flow diagram also shows a plurality of clients that utilize the nested funds verification system.

The plurality of clients that utilize the nested funds verification system may include universities/colleges, shown at 102, governments, shown at 104 and/or loan providers, shown at 106. Any other suitable clients may utilize the nested funds verification system. Each of these clients may identify, via the nested funds verification system, whether a prospective individual or prospective entity has sufficient funds to qualify for a specific relationship, as shown at 108. Each of these clients may also identify, via the nested funds verification system, whether an entity has sufficient funds to maintain an ongoing relationship.

One example of a client identifying whether a prospective individual has sufficient funds to qualify for a specific relationship may include a university identifying whether a prospective foreign student has sufficient funds to pay the costs of the university and any other costs associated therewith. The university may be a client of the nested funds verification system. The foreign student may be applying for acceptance into the university. Prior to accepting the foreign student into the university, the university may identify whether the prospective foreign student has access to sufficient funds to pay the university tuition and any other costs associated therewith. The nested funds verification system, on behalf of the university, may perform the funds verification of the foreign student.

Another example of a client identifying whether a prospective individual has sufficient funds to qualify for a specific relationship may include a non-native applying for a visa to enter a foreign country for an extended period of time. The government may be a client of the nested funds verification system. The non-native may be applying for an entry visa into the foreign country. In order to ensure that the non-native does not become a burden on the country, to which the non-native is applying for a visa, the government of the said country may require proof that the non-native has access to sufficient funds prior to the government issuing an entry visa. The nested funds verification system, on behalf of the government, may perform the funds verification of the non-native.

Another example of a client identifying whether a prospective entity has sufficient funds to qualify for a specific relationship may include a loan provider receiving a loan request from a loan requestor. The loan provider may be a client of the nested funds verification system. The loan requester may be an entity or individual. The loan requestor may be applying for a loan from the loan provider. The loan provider may request from the entity, or the individual, proof of assets as collateral for the loan. The nested funds verification system, on behalf of the loan provider, may perform the funds verification of the loan requester.

The entity or individual, which may be a student as described in the first example, is shown at 110. The entity or individual may have access to multiple asset sources. Such asset sources may include a savings account, shown at 112. Such asset sources may also include an investment account, shown at 114.

Such asset sources may also include a sponsor's account, shown at 116. The sponsor's account may be an account of a parent, guardian or another who is aiding, sponsoring or investing in the entity or individual.

Such asset sources may also include real estate, 118. It should be appreciated that real estate 118 may be an asset with a fluctuating value. As such, the nested funds verification system may include a submodule for identifying a current value for real estate 118. Such asset sources may also include any other suitable assets 120.

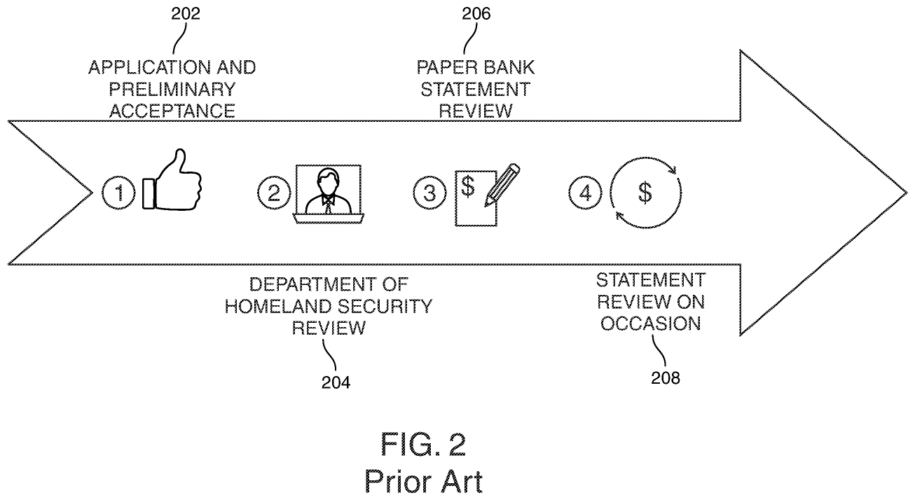

FIG. 2 shows exemplary steps for a prior art flow that portrays the acceptance requirements for a foreign student's acceptance into a United States educational institution. Such a student may enter the United States on an F-1 visa, also known as an academic student visa. Each year over one million students from foreign countries enroll in United States colleges and universities. Over 600,000 new foreign student applications are processed each year. There are multiple qualifications required from the students prior to acceptance into both the University and the United States. Universities and the United States Federal and State governments have financial qualifications for incoming students. Student visas are highly scrutinized in the United States and the visas are monitored throughout the student's stay in the United States.

Student may also apply for acceptance as a virtual student in a foreign university. Accordingly, because a virtual student may not be physically traveling into a foreign country, a virtual student may only be required to financially qualify for the university's financial qualifications and not for the government's financial qualifications.

The steps for the prior art flow include step 1, shown at 202, step 2, shown at 204, step 3, shown at 206, and step 4, shown at 208. Step 1 shows a foreign student applies for acceptance into a college or university. Such acceptance may include passing academic entrance exams, passing background checks and any other sort of preliminary acceptance criteria. Upon passing academic entrance exams, background checks and any other sort of preliminary acceptance criteria, the flow may proceed to step 2.

At step 2, shown at 204, a student may apply for an F-1 visa to enter the United States. The Department of Homeland Security, which is charged with the responsibility of border control and issuing visas in the United States, may perform a preliminary review of the student's credentials. Such a preliminary credential review may include a background check, which may or may not be the same background check as the one performed by the university. Such a preliminary credential review may include review of the academic acceptance to the University. Upon successful completion of the preliminary credential review, the flow may proceed to step 3.

At step 3, shown at 206, the student may be required to appear for an in-person visa application interview at the local United States embassy. At the in-person interview, the student must prove, among other qualifications, that the student has access to sufficient funds to attend the university and remain at the foreign country over the course of their enrollment in the university. Conventionally, in order to prove access to sufficient funds, the student prints out a paper statement of one account or of multiple account in the event that the balance is across multiple accounts. The individual at the embassy views the printed statements. In the event that the printed statement(s) shows the required balance, the individual at the embassy stamps the statement or provides a letter with a stamp on it. The stamp and/or the letter indicates the embassy's approval to provide the visa.

There are failures at this stage of the process. The process is a paper-based process and therefore prone to the above-mentioned document deficiencies. Paper statements only show a point in time. As such, after the statement is printed, the balance could be transferred to another account. Also, paper statements may have questionable authenticity. Furthermore, the individuals at the embassy may not be experts in recognizing documents with questionable authenticity. Once the process shown at step 206 is completed, the student may be issued an F-1 visa and acceptance into the university.

Step 4, shown at 208, may show an optional step. In some cases, universities and/or governments may re-verify funds during a student's stay in the United States. The reverification may also include showing a paper statement to a university or government official.

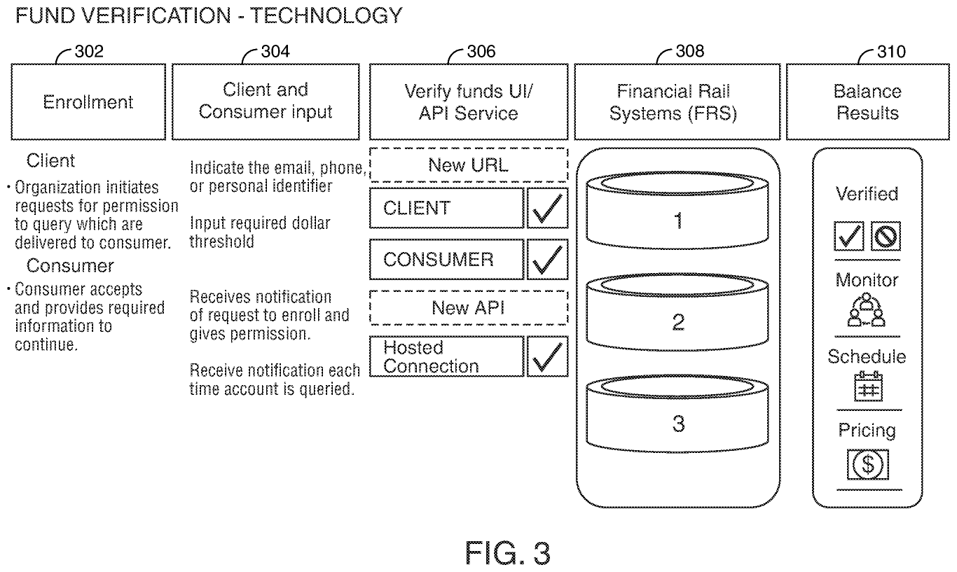

FIG. 3 shows a fund verification technology diagram. The fund verification technology diagram includes an enrollment section, shown at 302, a client and consumer input section, shown at 304, a verify funds user interface (“UI”)/application programming interface (“API”) service section, shown at 306, a financial rail systems (“FRS”) section, shown at 308, and a balance results section, shown at 310.

Enrollment section, shown at 302, depicts the enrollment of a client and a consumer into the fund verification system. The client may be an organization that is initiating a relationship with another individual or entity. The consumer may be the individual or entity with which the organization is initiating the relationship. The organization may initiate requests for permission to query data relating to the consumer. At enrollment, the requests to the query may be delivered to the consumer via the funds verification system. At enrollment, the consumer may accept and provide required information to continue. The required information may include bank account information, asset information, real estate information and any other suitable information. Such information may include permissions to query the aforementioned bank accounts, assets and real estate.

Client and consumer input section, shown at 304, shows input received from both the client and the consumer. The client (organization), after receiving permission from the consumer, may indicate the e-mail, phone or personal identifier of the consumer. The client (organization) may also input a dollar threshold. The dollar threshold may be a total dollar amount. In order to solidify the prospective relationship between the consumer and the client, the consumer may be required to prove access to funds greater than or equal to the total dollar amount. The consumer may receive notification of request to enroll in the funds verification system. The consumer may give permission to be enrolled in the fund verification system. The consumer may provide data, such as account information and real estate holdings, to the fund verification system. The consumer may receive a notification each time an account or real estate holding is queried. The notification may be received prior to the query, concurrent with the query and/or after the query has been completed.

Verify funds user interface/application programming service section, shown at 306, depicts the user interfaces and application programming interfaces utilized within the funds verification system. A new uniform resource locator (“URL”) may be assigned to provide a client-facing web interface. A new uniform resource locator (“URL”) may be assigned to provide a consumer-facing web interface. The URL that provides the client-facing web interface may be the same URL that provides the consumer-facing web interface. The URL that provides the client-facing web interface may be a different URL from the consumer-facing web interface. Additionally, a new application programming interface (“API”) may be assigned to provide a hosted connection to query the accounts and/or the real estate holdings associated with the consumer.

FRS section, shown at 308, depicts exemplary systems that can communicate with, or ping, consumer accounts. Examples of such systems may include Zelle®, Venmo® and SWIFT®. It should be appreciated that any suitable financial rail systems may be used to communicate with and/or ping consumer accounts. Also, a combination of financial rail systems may be used to communicate with and/or pin consumer accounts.

Zelle® is a payments' network that enables individuals to electronically transfer money from their bank account to another registered user's bank account using a mobile device or the website of a participating financial institution.

Zelle® may be operated by a group or plurality of financial institutions. Because the group of financial institutions operates Zelle®, a consumer may be able to generate a Zelle® transfer via the consumer's regular account. As such, the consumer may not be required to maintain a Zelle® account to initiate a Zelle® transaction.

Additionally, the consumer may be able to generate a Zelle® transfer through the consumer's regular bank account's user interface. As such, Zelle® may be relatively straightforward for a consumer to exploit.

Venmo® is a mobile payment service that enables account holders to transfer funds to others. Venmo® may require users to maintain accounts within the Venmo network. As such, a user may be required to maintain a Venmo® account in addition to a standard bank account. A user's Venmo® account may link to a standard bank account, credit and/or debit card.

Venmo® may operate its own user interface. The Venmo® user interface may be a social media-based interface. As such, payments made via Venmo® may be displayable to various groups of individuals.

SWIFT® is an acronym that stands for Society for Worldwide Interbank Financial Telecommunications. SWIFT® is a messaging network used by financial institutions to securely transmit messages and instructions through a standardized system of codes, colloquially known as SWIFT® codes. The SWIFT® network enables individuals and businesses to take electronic or card payments even if the customer uses a different bank than the payee. When the individuals or businesses transmit the bank account/card information to their respective bank, the bank communicates with the payer bank via one or more SWIFT® messages. The SWIFT® messages are standardized, and the requesting bank sends a SWIFT® message requesting the funds via the SWIFT® network to the payer bank. The payer bank sends a SWIFT® message back to the requesting bank acknowledging receipt of the requested funds.

It should be appreciated that the SWIFT® network is used to transport messages. The messages may include various message types. The messages may include payment orders. The messages may include any other suitable message types. However, SWIFT® does not facilitate funds transfer, rather the payment orders are settled by correspondent accounts that the institutions have with each other. As such, SWIFT® does not hold accounts for its members and does not perform clearing or settlement.

SWIFT® operates by assigning each member institution a unique identifier. The unique identifier may be referred to as a bank identifier code (“BIC”), SWIFT® code, SWIFT® ID or International Standardization Organization (“ISO”) 9362 code. The unique identifier may identify the bank name, the country, the city and the branch of the financial institution. The unique identifier may include eight or eleven characters. Characters one through four of the unique identifier may refer to the institute code. Characters five and six may refer to the country code. Characters seven and eight may refer to the location/city code. Characters nine, ten and eleven may refer to an individual branch. It should be appreciated that characters nine, ten and eleven, that refer to an individual branch, may be optional characters.

An exemplary use case of the SWIFT® network includes a U.S. retailer and an Indian manufacturer. The U.S. retailer requests a payment transmission to the Indian manufacturer. As such, the U.S. retailer instructs a U.S. bank to remit payment from the retailer's U.S.-based bank account to the manufacturer's Indian-based bank account. The U.S. bank generates a SWIFT® message. The SWIFT® message includes data relating to the incoming payment. The data may include sender information, receiver information and amount information. The data is formatted using SWIFT® codes. The SWIFT® message is transmitted over the SWIFT® network to the Indian bank. The Indian bank credits the manufacturer's account for the amount listed in the SWIFT® message. The payment is transferred from the U.S. bank to the Indian bank using a clearing and settlement system.

SWIFT® has the capability to transmit a variety of instructions in a structured approach. The various instructions include payment instructions, security transaction instructions, treasury transaction instructions, trade transaction instructions and system transaction instructions.

Additionally, a new set of rails may be used by the funds verification to communicate with consumer assets. This new set of rails may be authorized specifically for the purpose of identifying consumer assets. This new set of rails may only access a consumer account upon receipt of opt-in permission from the consumer associated with the consumer account. The new set of rails may operate together with the aforementioned financial rails. The new set of rails may operate separately from the aforementioned financial rails. A new set of rails may have the advantage that it is created for the purpose it is operating. As such, the technology may operate seamlessly for the purpose it was created. However, the previously available rails that may be able to be harnessed for the funds verification system may have the advantage of bandwidth savings. Because the rails are already in place, the funds verification systems may not involve creating and maintaining a new system, and the wasted computer bandwidth associated therewith. Rather, the funds verification system may be able to exploit the available rails for its own purposes.

Balance results section, shown at 310 includes various components of the funds verification systems. The funds verification system may enable a client to verify funds queries associated with a consumer.

The funds verification system may enable a client to monitor funds verification queries associated with a consumer throughout a predetermined time period. The monitoring may be executed on a periodic basis, such as on a schedule. The monitoring may also be executed on a constant basis. When the monitoring is executed on a constant basis, the funds verification system may alert the client when the consumer's assets drop below a predetermined threshold.

The funds verification system may enable a client to schedule funds verification queries with the consumer. As such, both the client and the consumer may be able to select a suitable schedule for funds verification.

The funds verification system may include a pricing model. The pricing model may include a charge to the client, a charge to the consumer or a charge to both the client and consumer.

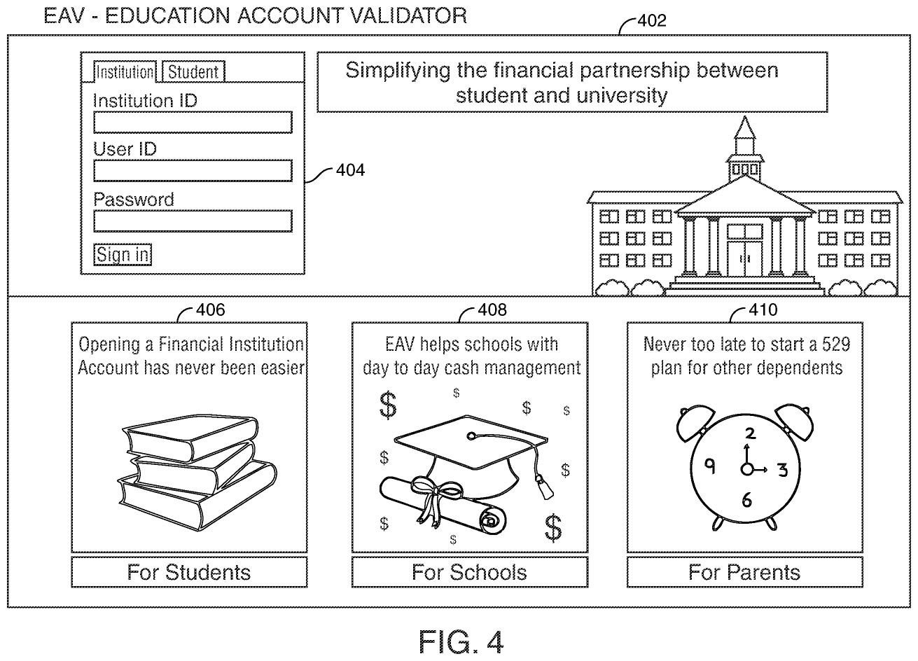

FIG. 4 shows an illustrative diagram. The illustrative diagram shows an exemplary user interface 402 for an education account validator (“EAV”). The EAV user interface 402 may be a webpage.

The EAV user interface may enable both a client, such as an institution, and a customer, such as a student, to interface with the funds verification system. Data entry box 404 enables a user, either the institution or the student, to enter login data. The login data, for the institution, may include an institution identifier, a user identifier and a password. The login data, for the institution, may include a student identifier, an institution identifier and a password. The login data may include any suitable login data.

The EAV user interface may include section 406. Section 406 may enable a user to select a student interface. The student interface may be designed for students to communicate with the funds verification system.

The EAV user interface may also include section 408. Section 408 may include a school interface. The school interface may be designed for an institution, such as a school to communicate with the funds verification system.

The EAV user interface may also include section 410. Section 410 may include a parent interface. The parent interface may be designed for parents of a student or prospective student to communicate with the funds verification system.

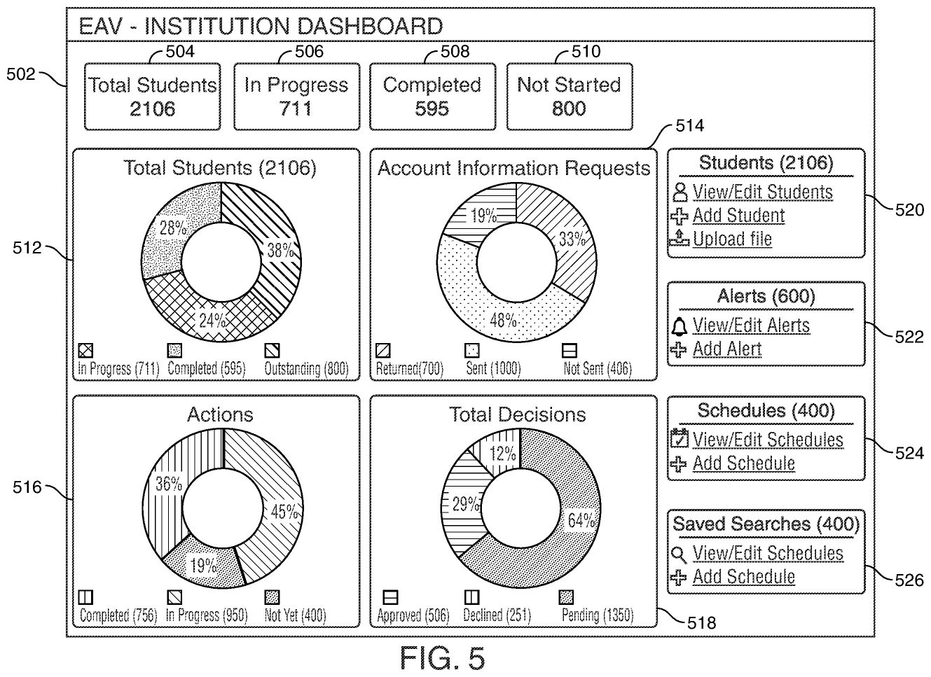

FIG. 5 shows an illustrative diagram. The illustrative diagram shows an exemplary web-based user interface 502 for an EAV—institution dashboard. The EAV—institution dashboard may include various components. The various components may include informational blocks 504, 506, 508 and 510. The various components may also include pie charts 512, 514, 516 and 518. Also, further information tabs 520, 522, 524 and 526 may enable a user to obtain further information and/or enter further information about the institution.

Informational block 504 may include the total number of students academically accepted into the institution. Pie chart 512 may include a breakdown of the number of students included in the institution. The number of students who completed their financial enrollment may be 595, which is 28% of the total number of students in the institution. Informational block 508 may show the number of students who completed their financial enrollment.

The number of students whose financial enrollment is in progress may be 711, which is 24% of the total number of students in the institution. Informational block 506 may show the number of students whose financial enrollment is in progress.

The number of students whose financial enrollment is outstanding may be 800, which is 38% of the students in the institution. Informational block 510 may show the number of students whose financial enrollment is not yet initiated, also referred to as outstanding.

Account information requests pie chart, shown at 514, may include requests sent for account information. Each of the account information requests may be sent to a student. Once the account information request is approved by the student, the EAV may be able to query the assets associated with the student. The account information requests shown may include the number of requests that have been returned (700), which may be 33% of the total number of students. The account information requests shown may include the number of requests that have been sent (1000), which may be 48% of the total number of students. The account information requests shown may include the number of requests that have not been sent (406), which may be 19% of the total number of students.

Actions pie chart, shown at 516, may include actions taken for each of the students. An action may be a query to an asset associated with a student. The actions shown may include the number of actions that have been completed (756), which may be 36% of the total number of students. The actions shown may include the number of actions that are in progress (950), which may be 45% of the total number of students. The actions shown may include the number of actions that have not yet been started (400), which may be 19% of the total number of students.

Total decisions pie chart, shown at 518, may include decisions made for each of the students. A decision may be a financial decision. The financial decision may be based on whether the student has sufficient funds to cover university tuition costs and other costs associated therewith. The total decisions pie chart may show 506 approved students, which may be 29% of the total number of students. The total decisions pie chart may show 251 declined students, which may be 12% of the total number of students. The total decisions pie chart may show 1350 pending students, which may be 64% of the total number of students.

Further information tab 520 may enable a user to view or edit students, to add students and to upload a file. The file may include data relating to a student.

Further information tab 522 may enable a user to view or edit alerts and to add an alert.

Further information tab 524 may enable a user to view or edit schedules and to add a schedule.

Further information tab 526 may enable a user to view or edit schedules and to add a schedule.

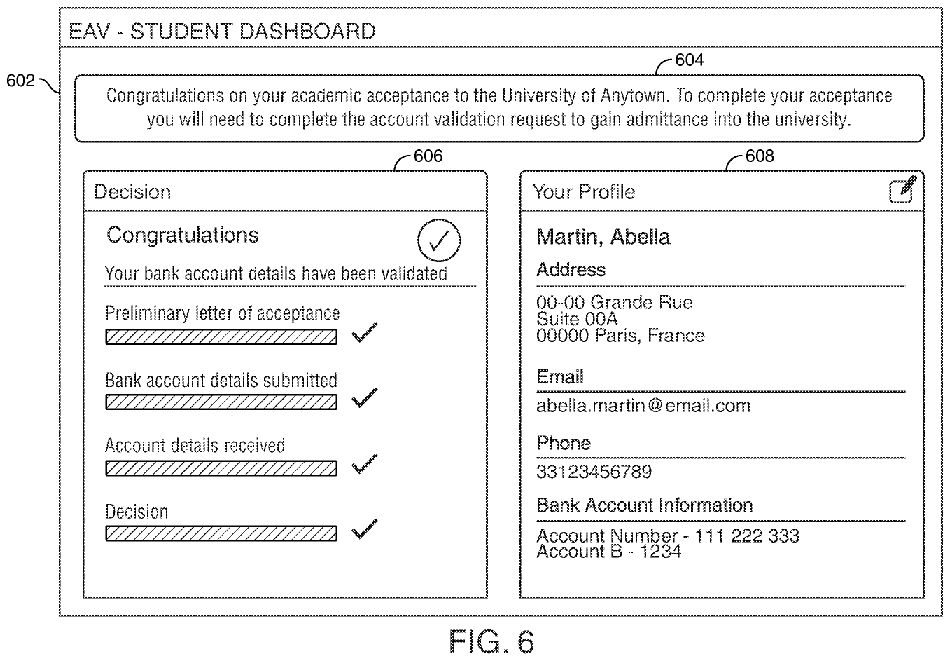

FIG. 6 shows an illustrative diagram. The illustrative diagram shows EAV—student dashboard 602. EAV—student dashboard 602 may display information to a student user.

Banner 604 may congratulate the user on the student's academic acceptance to the university. Banner 604 may instruct the user to complete the account validation request to gain admittance into the university.

Decision box 606 may include details relating to the financial account validation. Decision box 606 informs the user that the bank account details have been validated. Decision box 606 also informs the user that a preliminary letter of acceptance has been sent to the student. The preliminary letter of acceptance may indicate academic acceptance.

Decision box 606 also informs the user that bank account details have been submitted. The bank account details may relate to the financial acceptance into the university.

Decision box 606 also informs the user that account details have been received. The account details may relate to the financial acceptance into the university.

Decision box 606 also informs the user of the decision relating to the financial acceptance. The decision shown in decision box 606 may be acceptance.

Your profile box 608 may include details relating to the profile of the student. The details may include the name, the address, the email address, the phone number and the bank account information. It should be appreciated that the student may enter a plurality of bank accounts into the bank account information field. The EAV system may query the bank accounts entered into the bank account information field. Although not shown, there may be an additional assets field. The additional assets field may include assets, such as real estate and valuables, that can be used as collateral for fees associated with the university. The EAV system may query the additional assets when determining whether the student qualifies for financial acceptance into the university.

The EAV system may query the assets utilizing available financial rails and/or new financial rails specifically for the purpose of querying assets. It should be appreciated that the EAV system may attempt to query the asset using available financial rails and in the event that available financial rails are unavailable for the specific asset being queried, the EAV system may generate a new rail specific for the purpose of querying the asset.

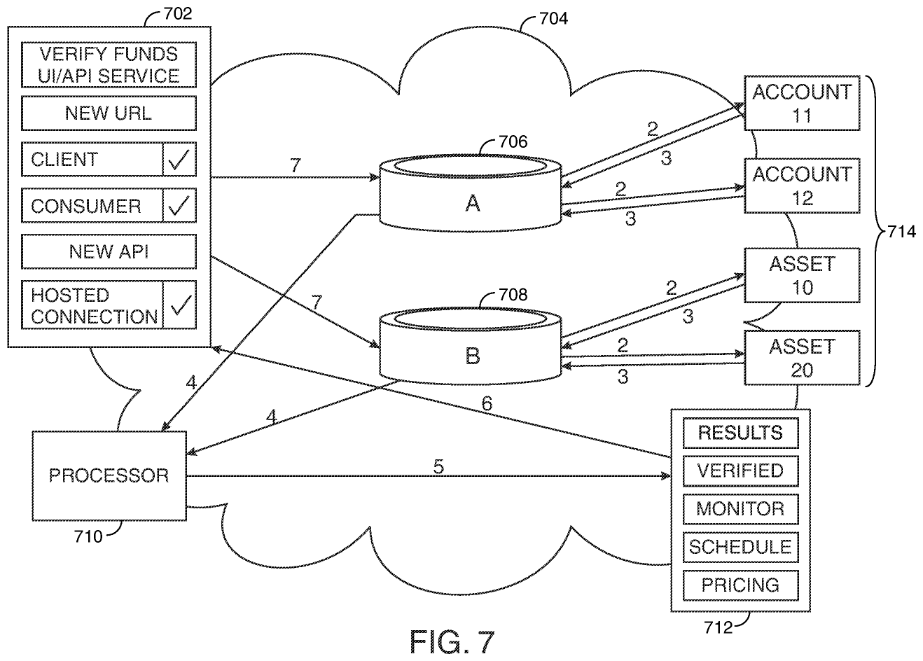

FIG. 7 shows an illustrative diagram. The illustrative diagram shows an exemplary architecture of a funds verification system.

Cloud environments enable fast communication between various locations around the globe. Because the system may communicate between various countries, the architecture may operate in a cloud environment, as shown at 704.

Funds verification UI/API service 702 may include a new URL for a client and a consumer. Funds verification UI/API may also include a new API that comprises a hosted connection. The funds verification UI/API may include capabilities described in connection with verify funds UI/API service section 306, shown in FIG. 3.

Funds verification UI/API service 702 may receive data from the client and the consumer. The client may enter consumer data after receiving opt-in permission from the consumer. The received consumer data may include name, telephone number, e-mail address, address and any other suitable profile data.

Once the funds verification system receives consumer data from the client, the funds verification system may be able to communicate with the consumer. The consumer may communicate asset information to the funds verification system. The asset information may include account 11, account 12, asset 10 and asset 20, shown at 714. It should be appreciated that the assets may be located globally in various currencies. The assets may be one or more bank accounts. The bank accounts may be associated with the consumer and/or with a sponsor of the consumer. The assets may be non-liquid assets. Such non-liquid assets may include real estate, valuables and any other suitable non-liquid assets.

Funds verification system may communicate, via the application programming interface, with financial rails 706 and 708, as indicated by the arrows labeled 1. It should be appreciated that financial rails 706 and 708 may be financial rails that are used for other payment purposes. Such rails may be typically used to transfer funds from one entity account to another entity account. However, the funds verification system may harness the power of the funds transfer rails to determine balance information included in the accounts. As such, the funds verification system may preserve both processing power and bandwidth of generating a new funds verification rail system.

Financial rails 706 and 708 may query assets 714 including account 11, account 12, asset 10 and asset 20, to identify a numerical value associated with each asset, as indicated by the arrows labeled 2. Assets 714 may respond to the query with the numerical value associated with the asset, as indicated by the arrows labeled 3. At times, one financial rail may be specific to a certain asset type. For example, one financial rail may be specific to bank accounts. Another financial rail may be able to identify a value of a real estate. Such a financial rail may communicate with one or more sources for identifying a value of real estate associated with a street address. Yet another financial rail may be able to identify a value of precious gems. Such a financial rail may communicate with one or more sources for identifying a value of gem based on its properties.

Financial rails 706 and 708 may communicate the values received from assets 714 to processor 710. Processor 710 may be a hardware processor. Processor 710 may aggregate the total amount of assets 714. Processor 710 may determine whether the total amount of assets 714 reaches a minimum asset amount identified by the client. Based on the identification, processor 710 may transmit a result, as shown at arrow labeled 5, to results module 712. Results module 712 may determine a result. The result may include a verification result (the total identified assets is equal to or exceeds the minimum asset amount). The result may include a monitor result (whether assets 714 require intermittent or continual monitoring). The result may include a schedule result (a schedule for determining the value for assets 714). The result may include a pricing result (the cost for determining the value for assets 714). The results may be transmitted to verification funds UI/API service 702, as indicated by arrow labeled 6.

Thus, a nested funds verification system is provided. Persons skilled in the art will appreciate that the present invention can be practiced by other than the described embodiments, which are presented for purposes of illustration rather than of limitation. The present invention is limited only by the claims that follow.

What is claimed is:

1. A method for protecting the privacy of a consumer during execution of a nested funds verification of the consumer, the method comprising:
receiving, from the consumer, at an entity, a request for initiation of a predetermined relationship;
receiving, from the consumer, at the entity, a personal identifier;
initiating, at an entity-side user interface, a request for permission to execute a query on a plurality of confidential files associated with the consumer;
receiving user input at the entity-side user interface, the user input comprising the personal identifier associated with the consumer;
delivering, to the consumer, a request to approve opt-in permission to execute the query the consumer;
receiving, from the consumer, approval of the request to execute the query the consumer;
executing the query on the plurality of confidential files identified by the personal identifier, wherein the executing is transparent to the consumer as to which files are queried and the executing is obscured from view and inaccessible by the entity;
presenting, to the entity, at the entity-side user interface an approval or a denial of the query.

2. The method of claim 1, further comprising receiving, at the consumer, a notification each time the plurality of confidential files is queried.

3. The method of claim 1, further comprising:
receiving a user input at the entity-side user interface, the user input comprising a predetermined asset threshold;
approving the query when the query identifies that the consumer has access to greater than the predetermined asset threshold; and
denying the query when the query identifies that the consumer has access to less than the predetermined asset threshold.

4. The method of claim 1, wherein the executing the query comprises identifying a bank account identified by one or more confidential files included in the plurality of confidential files, determining a current value for the bank account in a predetermined currency.

5. The method of claim 1, wherein the executing the query comprises:
identifying a plurality of bank accounts identified by one or more confidential files included in the plurality of confidential files;
identifying a lowest value, for each bank account included in the plurality of the bank accounts for a past predetermined time period, in a uniform predetermined currency;
aggregating, into an aggregated amount, all of the lowest values of each of the bank accounts included in the plurality of bank accounts;
comparing a minimum amount, inputted by the entity, to the aggregated amount;
approving the query when the minimum amount is less than or equal to the aggregated amount; and
denying the query when the minimum amount is greater than the aggregated amount.

6. The method of claim 1, wherein the executing the query comprises:
identifying a first plurality of bank accounts identified by one or more confidential files included in the plurality of confidential files;
identifying a secondary plurality of bank accounts, identified by one or more confidential files included in the plurality of confidential files, that communicate with the first plurality of bank accounts for a past predetermined time period;
identifying a tertiary plurality of bank accounts, identified by one or more confidential files included in the plurality of confidential files, that communicated with the secondary plurality of bank accounts for the past predetermined time period;
identifying a total amount of combined assets for the first plurality of bank accounts, secondary plurality of bank accounts and tertiary plurality of bank accounts;
comparing a minimum amount, inputted by the entity, to the total amount of combined assets;
approving the query when the minimum amount is less than or equal to the total amount of combined assets; and
denying the query when the minimum amount is greater than the total amount of combined assets.

7. The method of claim 1, further comprising utilizing existing financial rails to execute the query on the plurality of confidential files.

8. A system for protecting the privacy of a consumer during execution of a nested funds verification of the consumer, the system comprising:
a web-based interface comprising:
an entity-facing side; and
a consumer-facing side; and
an internal processing executable executing on a processor, said internal processing executable obscured from, and inaccessible to, both the entity-facing side and the consumer-facing side;
wherein the entity-facing side of the web-based interface is operable to:
prompt a user to provide opt-in permission;
receive profile data from the consumer;
generate a record for the consumer;
receive a user input of a minimum asset amount; and
initiate a funds verification process for the consumer;
wherein the consumer-facing side of the web-based interface is operable to:
provide the opt-in permission for the web-based interface to access asset data associated with the consumer; and
receive a user input relating to asset data associated with one or more assets;
wherein, upon receipt of the opt-in permission from the consumer-facing side of the web-based interface, the internal processing executable is operable to:
query the one or more assets to determine whether the one or more assets, alone or in combination, include the minimum assets amount;
determine, based on a comparison of the one or more assets to the minimum asset amount, an approval or a denial to the query; and
present the approval or the denial to the entity-facing side and the consumer-facing side of the web-based interface, while shielding the entity-facing side and the consumer-facing side from details included in the one or more assets.

9. The system of claim 8, wherein the query is executed a plurality of instances according to a predetermined schedule.

10. The system of claim 9, wherein a notification is presented to the consumer-facing side prior to execution of each query instance included in the plurality of instances.

11. The system of claim 8, wherein the query includes determining whether the one or more assets in the minimum assets amount has been maintained for a historical predetermined time period.

12. The system of claim 8, wherein the executing the query comprises:
identification of a first plurality of assets;
identification of a secondary plurality of assets that communicate with the first plurality of assets for a historical predetermined time period;
identification of a tertiary plurality of assets that communicated with the secondary plurality of assets for the historical predetermined time period;
identification of a total amount of combined assets for the first plurality of assets, secondary plurality of assets and tertiary plurality of assets; and
executing the query on the total amount of combined assets.

13. The system of claim 12, wherein the secondary plurality of assets comprises equity associated with a parcel of real estate.

14. The system of claim 8, wherein the internal processing executable utilizes existing financial rails to execute the query on the one or more assets.

15. A system for protecting the privacy of a consumer during execution of a nested funds verification of the consumer, the system comprising:
a web-based interface comprising:
an entity-facing side; and
a consumer-facing side; and
an internal processing executable executing on a processor, said internal processing executable obscured from, and inaccessible to, both the entity-facing side and the consumer-facing side;
wherein the entity-facing side of the web-based interface is operable to:
prompt a user to provide opt-in permission;
receive profile data from the consumer;
generate a record for the consumer;
enter a minimum asset amount; and
initiate a funds verification process for the consumer;
wherein the consumer-facing side of the web-based interface is operable to:
receive a user input comprising opt-in permission for the web-based interface to access asset data associated with the consumer; and
receive a user input comprising asset data associated with one or more assets;
wherein, upon receipt of the opt-in permission from the consumer-facing side of the web-based interface, the internal processing executable is operable to:
execute a query, using a plurality of existing financial rails, on the one or more assets to determine whether the one or more assets, alone or in combination, include the minimum assets amount;
in the event that the plurality of existing financial rails fails to query the one or more assets:
generate new financial rails, said new financial rails operable to communicate with the one or more assets; and
execute the query, using the new financial rails, on the one or more assets;
determine, based on a comparison of the one or more assets to the to the minimum asset amount, an approval or a denial to the query; and
present the approval or the denial to the entity-facing side and the consumer-facing side of the web-based interface, while shielding the entity-facing side and the consumer-facing side from details included in the one or more assets.

16. The system of claim 15, wherein the query is executed a plurality of instances according to a predetermined schedule.

17. The system of claim 15, wherein a notification prior to each of execution of the query.

18. The system of claim 15, wherein the query includes determining whether the one or more assets in the minimum assets amount has been maintained for a past predetermined time period.

19. The system of claim 15, wherein the executing the query comprises:
identification of a first plurality of assets;
identification of a secondary plurality of assets that communicate with the first plurality of assets for a past predetermined time period;
identification of a tertiary plurality of assets that communicated with the secondary plurality of assets for the past predetermined time period;
identification of a total amount of combined assets for the first plurality of assets, secondary plurality of assets and tertiary plurality of assets; and
executing the query on the total amount of combined assets.

20. The system of claim 19, wherein the secondary plurality of assets comprises equity associated with a parcel of real estate.
